(19) United States
(12) Patent Application Publication
(10) Pub. No.: US 2018/0334996 A1
(43) Pub. Date: Nov. 22, 2018

(54) Hybrid Rocket Motor

(71) Applicant: Streamline Automation LLC, Huntsville, AL (US)

(72) Inventors: William Chew, Huntsville, AL (US); Geoffrey Chew, Huntsville, AL (US)

(21) Appl. No.: 15/983,809

(22) Filed: May 18, 2018

Related U.S. Application Data
(60) Provisional application No. 62/509,153, filed on May 21, 2017.

(51) Int. Cl. F02K 9/28; F02K 9/97

(52) U.S. Cl. CPC F02K 9/28; F02K 9/97

(57) ABSTRACT

Hybrid rocket motors having fuel grains containing glycidyl azide polymer (GAP) produce high regression rates and can be stopped and restarted. The fuel grains also contain carbon and optionally either hydroxyl-terminated polybutadiene (HTPB) or polyethylene glycol (PEG). TGAP self-deflagration in the hybrid rocket motors is controlled by at least one of motor design and the amount of carbon in the fuel grain.

### CROSS-REFERENCE TO RELATED APPLICATIONS

This application claims priority to U.S. 62/509,153 filed May 21, 2017.

### FEDERALLY SPONSORED RESEARCH OR DEVELOPMENT

The U.S. Government may have certain rights to this invention pursuant to Contract Number HQ0147-15-C-7249 awarded by the Missile Defense Agency.

### BACKGROUND OF THE INVENTION

### Field of the Invention

The present invention relates to a hybrid rocket motor comprising a glycidyl azide polymer (GAP) with a high regression rate.

### Description of Related Art

A hybrid rocket motor comprises a solid fuel located in a combustion chamber and a fluid oxidizer that is passed through the combustion chamber to react with the fuel. In a simplest form, a hybrid rocket motor consists of a storage vessel containing oxidizer, a combustion chamber containing solid fuel, an ignition source, and a means for injecting oxidizer into the combustion chamber. Upon activation, the oxidizer flows into the combustion chamber where it reacts with the solid fuel after ignition with combustion occurring in a boundary layer along the surface of the solid fuel. The oxidizer does not react directly with the solid fuel but with fuel decomposition products released from the surface of the fuel. The solid fuels most commonly used in hybrid rocket motors include hydroxyl-terminated polybutadiene (HTPB), polyethylene, and paraffin wax, which may be mixed with fuel additives such as aluminium, lithium, or metal hydrides. Commonly used oxidizers include gaseous or liquid oxygen, nitrous oxide, hydrogen peroxide, red fuming nitric acid, and mixed oxides of nitrogen (MON). Generally, a fuel is paired with one specific oxidizer for optimal performance and the oxidizer cannot be changed without modification. Most hybrid rocket motors can be stopped, restarted, and throttled by controlling the flow of oxidizer.

One important factor that has limited the use of hybrid rocket motors involves the rate at which fuel is consumed, which is usually expressed as a fuel grain regression rate in units of distance divided by time. The regression rate expresses the rate at which at which fuel vaporizes or ablates off of the fuel grain surface so that the fuel can react with an oxidizer in a combustion process. A higher regression rate is associated with a higher rate of fuel consumption and higher thrust. Several factors are associated with limitations to the regression rate, and therefore the thrust, of existing hybrid rocket motors. A number of approaches have been taken to overcome these limitations.

U.S. Pat. No. 5,367,872 poses a solution to the problem of low regression rate by providing multiple fuel grains that are rotated or offset relative each other so that axial perforations of one fuel grain are canted or misaligned relative to an adjacent grain. This is intended to maximize oxidizer and gaseous combustion product turbulence within the rocket motor and increase solid fuel surface area, producing improved heat transfer and oxidizer transport to the solid fuel surface. An advantage of the invention is the avoidance of energetic additives such as oxidizers in the fuel and formulations comprising glycidyl azide polymer (GAP) because these additives and formulations result in fuels that are self-deflagrating. A rocket motor comprising a self-deflagrating fuel cannot be shut down by stopping the flow of oxidizer and later restarted. Drawbacks associated with multiple offset fuel grains include relatively poor volumetric efficiency and an increased likelihood of structural deficiencies.

EP0520104 A1 discloses hybrid rocket motor fuel grain compositions with high regression rates that are non-self-deflagrating. These regression rates are obtained using oxygen as the oxidizer at a relatively low mass flux of from 0.3 to 0.4 lb/sec/in with a solid fuel comprising glycidyl azide polymer (GAP) in a matrix of a non-energetic (inert) polymer fuel such as polybutadiene (PB). A preferred composition comprises 24% GAP, 56% hydroxy-terminated PB (HTPB), and 20% Aluminum metal. Pure GAP was found to be self-deflagrating at 1000 psi chamber pressure but, when blended with at least 30% by weight of HTPB, a homogeneous castable fuel mixture was produced that was not self-deflagrating. Thus, the problem of self-deflagrating fuels containing GAP was solved by the inclusion in the fuel of at least 30% HTPB and preferably 56% HTPB.

Hori (2009) “Application of Glycidyl Azide Polymer to Hybrid Rocket Motor” AIAA Paper 2009-5348 discloses that an advantage of using GAP fuel in hybrid rockets is its self-combustibility (deflagration) and discloses a hybrid rocket motor in which GAP is deflagrated in a primary “combustor” without oxidizer and fuel-rich deflagration products are injected into a secondary combustor where complete combustion takes place in the presence of oxidizer. Hori discloses that polyethylene glycol (PEG) can be added to GAP fuel to suppress combustion and improve mechanical properties of the fuel but that the addition of PEG to the fuel lowers its energy content. According to Hori, a mixture of GAP and PEG comprising up to 40 mass % PEG is self-combustible (deflagrating). This reference uses the term “combustion” to include both deflagration, which occurs in the absence of oxidizer, and combustion, which takes place in the presence of oxidizer. In this case the self-deflagration of GAP is used to generate a gaseous GAP decomposition products that are combusted in a combustion chamber positioned downstream of a deflagration chamber.

U.S. Pat. No. 6,865,878 discloses a hybrid rocket engine that generates a fluid vortex spiraling toward a closed end of a combustion chamber and an inner fluid vortex that spirals toward an open end of the combustion chamber. This is intended as an improvement over hybrid rocket engines in which oxidizer and vaporized fuel traverse the combustion zone on a linear path because the vortex effectively increases the surface area available for combustion and allows for a more complete combustion. This, in turn, eliminates the need for a secondary combustion chamber, which adds length and weight to the rocket engine and may additionally be a source of combustion instability.

McCulley, J. “Design and Testing of Digitally Manufactured Paraffin Acetonitrile-Butadiene-Styrene Hybrid Rocket Motors” (2013) Master's Thesis, Utah State University discloses that additive manufacturing may be used increased regression rates of paraffin-containing fuel grains. This involves sequential layering of fuel while manufacturing the grain.

Carbon black is well known as an additive to hybrid motor fuel grains to absorb radiant heat, which increases the surface temperature of the fuel grain during combustion but prevents deeper radiant heating in the fuel grain. Increasing the surface temperature facilitates fuel decomposition at the surface.

Despite the existing strategies for increasing the regression rates of hybrid rocket motors, including those mentioned above, the need for further improvements to hybrid rocket motors exists.

### BRIEF SUMMARY OF THE INVENTION

The present invention provides for hybrid rocket motors having high regression rates that can be stopped and restarted. The hybrid rocket motors have fuel grains comprising glycidyl azide polymer (GAP) and, optionally, either hydroxyl-terminated polybutadiene (HTPB) or polyethylene glycol (PEG). The invention provides for a hybrid rocket motor having a fuel grain comprising 60% to 100% GAP fuel polymer and carbon. The problem of self-deflagration in hybrid motors comprising high ratios of GAP to non-energetic polymer is solved by motor design and/or controlling the amount of carbon in the fuel grain.

### BRIEF DESCRIPTION OF THE DRAWINGS

The elements of the drawings are not necessarily to scale relative to each other, with emphasis placed instead upon clearly illustrating the principles of the disclosure. Like reference numerals designate corresponding parts throughout the several views of the drawings in which:

FIG. 1 is a schematic showing a hybrid rocket motor comprising an external pintle that controls pressure inside a combustion chamber and the flow of combustion products through a nozzle throat;

FIG. 2 is a schematic showing a hybrid rocket motor comprising an external pintle that controls the flow of combustion products through a nozzle throat and a pair of thrust balanced valves that control pressure inside a combustion chamber; and

FIG. 3 is a schematic showing a hybrid rocket motor comprising first and second combustion chambers and an internal pintle that controls the flow of combustion products through a nozzle throat and the pressure inside both combustion chambers.

FIG. 4 is a graph showing rise in pressure change over time for sample fuel grains.

### DETAILED DESCRIPTION OF THE INVENTION

Specific embodiments of the invention are described with reference to the accompanying drawings. This invention may, however, be embodied in many different forms and should not be construed as limited to the embodiments set forth herein; rather, these embodiments are provided so that this disclosure will be thorough, complete, and adequately convey the details of the invention to those skilled in the art.

As used herein, a hybrid rocket motor is a rocket motor that combusts a solid fuel using a stream of a fluid oxidizer. This is distinct from an air-breathing engine that uses oxygen in the air as a source of oxidizer.

As used herein, “neutral thrust” valves or “thrust neutral” valves refers to 2 or more pressure valves that are positioned relative to one another on a hybrid rocket motor such that no net thrust is produced when the valves are opened. The gas vented through each of the valves may be computer controlled, for example by a processor coupled to an accelerometer.

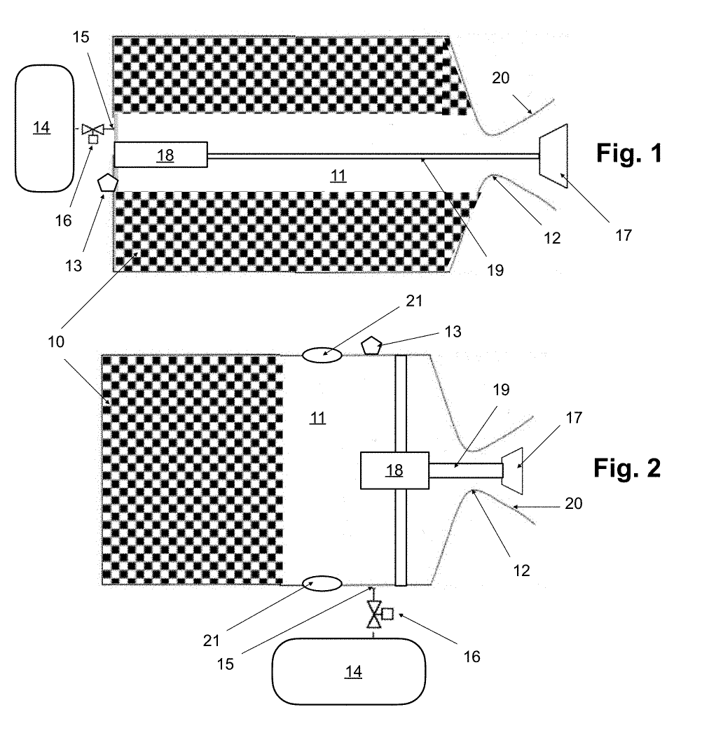

FIG. 1 shows a hybrid rocket motor comprising a fuel grain (10) positioned inside a combustion chamber (11) having a nozzle comprising a nozzle throat (12). The fuel grain (10) comprises glycidyl azide polymer (GAP) in an amount of at least 60% by weight and preferably at least 70% by weight. The grain may additionally comprise hydroxyl terminated polybutadiene (HTPB) and/or polyethylene glycol (PEG) such that the ratio of GAP to HTPB+PEG is at least 7:1. The fuel grain may additionally comprise carbon black powder in an amount of up to 25% by weight. Curing agents such as polyisocyanates are employed to cure hydroxy or epoxy terminated resins, and diaziridines, triaziridines, diepoxides, triepoxides and combinations thereof are used as curing agents for carboxy terminated resins. Normally, the amount of curing agent does not exceed 15% by weight. The curing of GAP, HTPB, and PEG polymers found in hybrid rocket motors is known to those of skill in the art.

An oxidizer injector (15) is configured to introduce an oxidizer from a source of oxidizer (14) into the combustion chamber (11) through an oxidizer injector (15). Flow of oxidizer into the combustion chamber is controlled by an oxidizer flow control valve (16). The hybrid rocket motor comprises an ignition source, or ignitor (13), used to ignite a mixture of fuel and oxidzer to initiate combustion in the combustion chamber (11). The ignitor (13) may comprise a torch having its own fuel, oxidizer, and ignition source wherein the torch heats a portion of the fuel grain (10) and ignites a mixture of fuel grain vapor and oxidizer. When oxidizers such as oxygen and liquid oxygen are used, an ignition source capable of vaporizing a portion of the fuel grain may not be required and electrical and/or laser ignitors may be used.

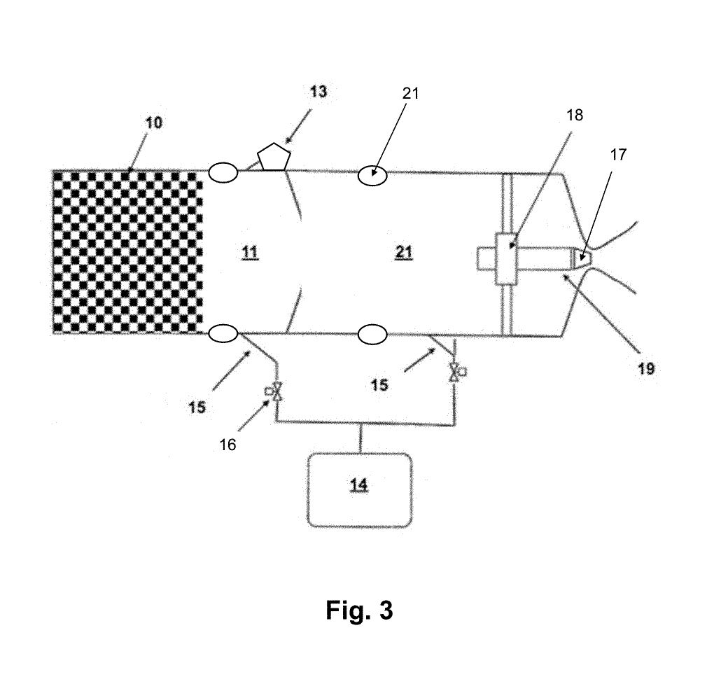

Once combustion begins, the pressure inside the combustion chamber (11) may be controlled by a pintle (17) that is movable with respect to the nozzle throat (12) by an actuator (18) coupled to the pintle (17) via a mechanical linkage (19) such as a rod, bar, or shaft. The actuator (18) may be supported by attachment to points inside the combustion chamber (11) and/or second combustion chamber (31) (FIG. 3), for example by direct fastening to a surface of the combustion chamber or via structural supports anchored to the combustions chamber and supporting the actuator. The pintle (17) may be positioned external to the combustion chamber (11) and inside nozzle cone (20) as shown in FIG. 1, or it may be positioned inside the combustion chamber (11) as shown in FIG. 3. The opening between the pintle (17) and nozzle throat (12) in FIG. 1 is adjustable to allow the pressure inside the combustion chamber (11) to drop below a predetermined threshold sufficient to stop self-deflagration of the GAP containing fuel grain (10). The size of the opening is a function of the radius of the nozzle throat and the distance between the pintle (17) and nozzle throat (12). It is also possible to design a combustion chamber with a nozzle throat cross-section that, for a particular fuel composition, does not require a pintle (17) to control combustion chamber pressure.

FIG. 2 is a schematic of a hybrid rocket motor comprising neutral thrust valves (21) that, together with the pintle (17), control pressure inside the combustion chamber (11). The motor is configured such that the pressure inside the combustion chamber drops below a predetermined threshold sufficient to stop self-deflagration of the GAP containing fuel grain (10) when the pintle and the neutral thrust valves (21) are controlled to open to a predetermined degree. Two neutral thrust valves (21) are shown in the figure but any number of valves greater than one may be used as long as they are properly configured in the motor. The fuel grain may comprise the same components as in FIG. 1. The pintle (17) and/or the neutral thrust valves (21) may not be necessary in certain embodiments in which the nozzle throat cross section is large enough for pressure inside the combustion chamber (11) to drop to desires levels when the oxidizer flow control valve (16) is closed.

FIG. 3 is a schematic of a hybrid rocket motor comprising a fuel grain (10), as in FIGS. 1 and 2. The fuel grain (10) is located inside a first combustion chamber (11) from which combustion products escape into a second combustion chamber (31) for further combustion. Oxidizer is provided to the first and second combustion chambers (11,31) from a source of oxidizer (14) through injector (15). Flow of oxidizer to the combustion chambers may be controlled independently via control valves (16). The figures shows a single oxidizer supply (14) feeding the same oxidizer to the first and second combustion chambers. Alternatively, different oxidizers may be provided to the different combustion chambers from different supplies of oxidizer. The hybrid rocket motor shown in FIG. 3 comprises neutral thrust valves (21) and a pintle valve (17) for controlling the pressures inside the first and second combustion chambers. By opening the neutral thrust valves and pintle valve to a predetermined degree, the pressure within the first combustion chamber may be reduced to a predetermined level to prevent the self deflagration of the fuel grain (19) in the first combustion chamber (11). In alternative embodiments, the pintle valve (17) may be configured to be on the outside of the second combustion chamber as shown in FIG. 1 or 2 with a single combustion chamber. In other alternative embodiments, the neutral thrust valves (21) may be omitted from the first combustion chamber and internal or external pintle valve (17) may be configured to open wide enough for the pressure in the second combustion chamber and the first combustion chamber to be lowered to a predetermined pressure to prevent self-deflagration of the fuel grain.

With no intention to be limited to theory, it is believed that self deflagration is halted by a rapid separation of heat-generating combustion from the fuel grain surface so that further vaporization of the fuel surface is retarded. Lowering of the pressure inside a combustion chamber is, therefor, sudden or rapid enough to produce the desired separation. The pressure inside the combustion chamber is preferably lowered to less than 350 psi. It is also possible to pass an inert gas across the surface of the fuel at high velocity to separate the hot gasses form the surface of the solid fuel to terminate self-deflagration.

Additionally or alternatively, self deflagration of high GAP fuel grains can be prevented by the addition of carbon black. The inventors have surprisingly found that the addition of carbon black retards the self deflagration of fuel grains with high GAP:HTPB and/or PEG ratios (e.g. 7:1 or higher) with little or no reduction in Isp. Inclusion of carbon black also increases the Shore A hardness of the fuel grain, which facilitates GAP:HTPB and/or PEG ratios up to 1:0 (i.e. GAP as the only polymer fuel). GAP alone is a much softer polymer than HTPB.

Generally, the fuel grains are prepared by combining GAP, HTPB (if present), and carbon, adding MDI, mixing under vacuum, adding a catalyst such as dibutyltin dilaurate (DBTDL) or triphenyl bismuth (TPB), mixing under vacuum, and casting the grain. The amounts of curing agents may be varied to control curing time and final hardness of the fuel grain. The amount of catalyst ranges from approximately 0.03% to 0.6% by weight. It is preferred that the amounts of the cross-linking agents used results in a cured fuel grain having a Shore A hardness of from 12 to 70. GAP and PEG mixtures may be cured at room temperature using trimethylol propane (TMP) as a crosslinking agent and hexamethylene diisocyanate (HMDI) as a curing agent.

Examples of fuel grain compositions are provided in Table 1 below:

| GAP:HTPB | % C |
|---|---|
| mass | mass |
| 1:0 | 0.25 |
| 1:0 | 1 |
| 1:0 | 5 |
| 1:0 | 25 |
| 9.5:1 | 0.1 |
| 9.5:1 | 0.33 |
| 9.5:1 | 1 |
| 9.5:1 | 5 |
| 9.5:1 | 15 |
| 9.5:1 | 25 |
| 9:1 | 0.1 |
| 9:1 | 0.33 |
| 9:1 | 1 |
| 9:1 | 5 |
| 9:1 | 15 |
| 9:1 | 25 |
| 8.5:1 | 0.1 |
| 8.5:1 | 0.33 |
| 8.5:1 | 1 |
| 8.5:1 | 5 |
| 8.5:1 | 15 |
| 8.5:1 | 25 |
| 8:1 | 0.1 |
| 8:1 | 0.33 |
| 8:1 | 1 |
| 8:1 | 5 |
| 8:1 | 15 |
| 8:1 | 25 |
| 7:1 | 0.1 |
| 7:1 | 0.33 |
| 7:1 | 1 |
| 7:1 | 5 |
| 7:1 | 15 |
| 7:1 | 25 |
| 6.5:1 | 0.1 |
| 6.5:1 | 0.33 |
| 6.5:1 | 1 |
| 6.5:1 | 5 |
| 6.5:1 | 15 |
| 6:1 | 0.1 |
| 6:1 | 0.33 |
| 6:1 | 1 |
| 6:1 | 5 |
| 6:1 | 15 |
| 1:0 | 0.25 |
| 1:0 | 1 |
| 1:0 | 5 |
| 1:0 | 25 |
| 9.5:1 | 0.1 |
| 9.5:1 | 0.33 |
| 9.5:1 | 1 |
| 9.5:1 | 5 |
| 9.5:1 | 15 |
| 9.5:1 | 25 |
| 9:1 | 0.1 |
| 9:1 | 0.33 |
| 9:1 | 1 |
| 9:1 | 5 |
| 9:1 | 15 |
| 9:1 | 25 |
| 8.5:1 | 0.1 |
| 8.5:1 | 0.33 |
| 8.5:1 | 1 |
| 8.5:1 | 5 |
| 8.5:1 | 15 |
| 8.5:1 | 25 |
| 8:1 | 0.1 |
| 8:1 | 0.33 |
| 8:1 | 1 |
| 8:1 | 5 |
| 8:1 | 15 |
| 8:1 | 25 |
| 7:1 | 0.1 |
| 7:1 | 0.33 |
| 7:1 | 1 |
| 7:1 | 5 |
| 7:1 | 15 |
| 7:1 | 25 |
| 6.5:1 | 0.1 |
| 6.5:1 | 0.33 |
| 6.5:1 | 1 |
| 6.5:1 | 5 |
| 6.5:1 | 15 |
| 6:1 | 0.1 |
| 6:1 | 0.33 |
| 6:1 | 1 |
| 6:1 | 5 |
| 6:1 | 15 |

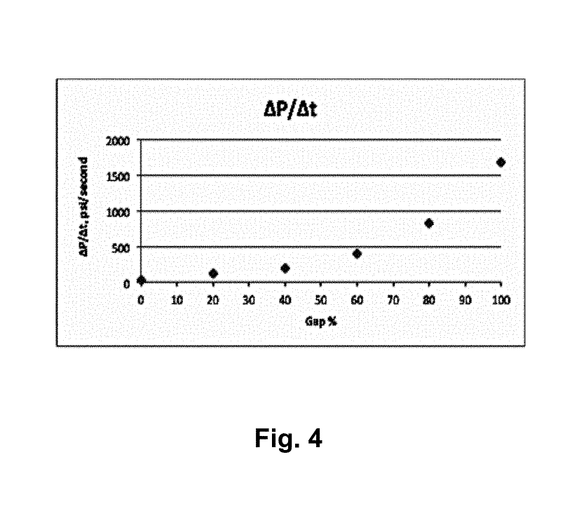

The rise in pressure change over time for sample fuel grains containing increasing weight percentages of GAP is shown in FIG. 4. The rise in pressure change over time increases nonlinearly with GAP content for test hybrid rocket motors comprising the fuel grains. The pressure rise rate for fuel grains containing more than 60% to 70% GAP by weight can be so high as to generate very high pressures in the combustion chamber, thereby inhibiting or reducing the flow of oxidizer into the combustion chamber. Consequently, in a preferred embodiment of a hybrid rocket motor according to the invention, the motor comprises a first combustion chamber containing the fuel grain and a second combustion chamber that receives partially combusted combustion products from the first combustion chamber. Oxidizer is provided to the second combustion chamber so that combustion is essentially complete in the second combustion chamber.

Another advantage of fuel grains comprising higher proportions of GAP relates to the change in temperature divided by weight, which decreases with increasing GAP concentration in the fuel grain. Although the theoretical Isp for the fuel grain decreases with increasing GAP concentration, the density impulse also increases. This is an advantage for volume limited applications such as divert attitude and control system (DACS). The change in temperature divided by weight decreases with increasing GAP concentration, which is consistent with the theoretical Isp correlation. Hybrid motor tests demonstrate that propellant density (density impulse), Pc, F, observed Isp, and regression rates all increase with GAP content. Thus, high GAP ratios (GAP content) provides a number of advantages in addition to high regression rates. The regression rates of motors with high GAP ratios may be higher than optimal for some applications. The regression rates may be reduced by incorporating carbon black powder in the fuel grain in amounts, for example, of 0.5%, 1%, 2%, 3%, 4%, 5%, 10%, 15%, or 25% depending on the composition, desired regression rate, and application.

The fuel grain formulations in the first combustion chamber may be tailored to provide a desired target regression rate. HTPB content may be reduced to reduce the amount of smoke generated by the rocket motor. Fuel grains comprising only GAP polymer, i.e. no HTPB process better than mixtures of HTPB and GAP but may have low Shore A hardness. The addition of carbon black results in fuel grains with higher Shore A hardness and fuel grains that are 100% GAP.

Additive manufacturing, including 3D printing and successive layering, may be used to make fuel grains having gradients of GAP content and/or carbon content to change the combustion characteristics of the motor during operation. For example the composition near the surface may be formulated such that the regression rate is higher for high powered flight and the composition further form the surface has a lower regression rate for longer sustained flight.

1. A hybrid rocket motor comprising:
a first combustion chamber containing a solid fuel, said solid fuel comprising glycidyl azide polymer (GAP) in an amount of at least 60% by weight;
a first oxidizer feed line connected to the first combustion chamber and configured to deliver oxidizer to the first combustion chamber from a supply of oxidizer;
a first oxidizer feed valve connected to the first oxidizer feed line and configured to control a flow of oxidizer into the first combustion chamber; and
a rocket exhaust nozzle at an aft end of the hybrid rocket motor, said nozzle comprising a nozzle throat.

2. The hybrid rocket motor of claim 1, further comprising a mechanism that lowers the pressure inside first combustion chamber from an operating pressure during combustion to a pressure of 350 psi or lower.

3. The hybrid rocket motor of claim 1, wherein said mechanism lowers the pressure inside first combustion chamber from an operating pressure during combustion to an ambient atmospheric pressure.

4. The hybrid rocket motor of claim 1, wherein the nozzle throat is configured to have a cross-sectional area such that pressure inside the combustion chamber decreases to a pressure of 350 psi or lower when the first oxidizer feed valve is closed.

5. The hybrid rocket motor of claim 1, comprising two or more thrust neutral valves positioned on the first combustion chamber such that, when the thrust neutral valves are opened and the first oxidizer feed valve is closed, pressure inside the first combustion chamber is reduced to 350 psi or lower.

6. The hybrid rocket motor of claim 1, wherein the solid fuel comprises GAP and hydroxy-terminated polybutadiene (HTPB) in a ratio of to 6:1 to 1:0.

7. The hybrid rocket motor of claim 1, wherein the solid fuel comprises GAP and polyethylene glycol (PEG) in a ratio of to 6:1 to 1:0.

8. The hybrid rocket motor of claim 1, wherein the solid fuel comprises a fuel grain in which the ratio of GAP to HTPB is non-uniform.

9. The hybrid rocket motor of claim 8, wherein the ratio of GAP to HTPB in the fuel grain changes radially and/or axially with respect to a central axis of the rocket motor.

10. The hybrid rocket motor of claim 1, wherein the solid fuel comprises carbon powder in an amount of from 0.15% by weight to 25% by weight.

11. The hybrid rocket motor of claim 10, wherein the solid fuel comprises a fuel grain in which a concentration of carbon powder is non-uniform.

12. The hybrid rocket motor of claim 11, wherein the concentration of carbon powder in the fuel grain changes radially and/or axially with respect to a central axis of the rocket motor.

13. The hybrid rocket motor of claim 1, further comprising
a second combustion chamber located between the first combustion chamber and the rocket nozzle, said second combustion chamber configured to receive combustion products from the first combustion chamber;
a second oxidizer feed line connected to the second combustion chamber and configured to deliver oxidizer to the second combustion chamber from a supply of oxidizer; and
a second oxidizer feed valve connected to the second oxidizer feed line and configured to control a flow of oxidizer into the second combustion chamber.

14. The hybrid rocket motor of claim 13, comprising a pintle that moves from a position in apposition to said nozzle throat to a distance from the nozzle throat sufficient to lower the pressure inside first combustion chamber from an operating pressure during combustion to a pressure of 350 psi or lower.

15. The hybrid rocket motor of claim 13, further comprising two or more thrust neutral valves positioned on the first combustion chamber.

16. A hybrid rocket motor comprising:
a first combustion chamber containing a solid fuel, said solid fuel comprising glycidyl azide polymer (GAP) in an amount of at least 70% by weight and carbon in an amount of from 0.15% to 25%;
a first oxidizer feed line connected to the first combustion chamber and configured to deliver oxidizer to the first combustion chamber from a supply of oxidizer;
a first oxidizer feed valve connected to the first oxidizer feed line and configured to control a flow of oxidizer into the first combustion chamber; and
a rocket exhaust nozzle at an aft end of the hybrid rocket motor, said nozzle comprising a nozzle throat;
wherein the cessation of oxidizer delivery to the first combustion chamber causes combustion to cease without self deflagration of the fuel grain.

17. The hybrid rocket motor of claim 16, wherein the solid fuel comprises GAP and hydroxy-terminated polybutadiene (HTPB) in a ratio of to 6:1 to 1:0 or GAP and polyethylene glycol (PEG) in a ratio of to 6:1 to 1:0.

18. The hybrid rocket motor of claim 16, wherein the solid fuel comprises a fuel grain in which the ratio of GAP to HTPB is non-uniform.

19. The hybrid rocket motor of claim 16, wherein the solid fuel comprises a fuel grain in which a concentration of carbon powder is non-uniform.

20. The hybrid rocket motor of claim 16, further comprising
a second combustion chamber located between the first combustion chamber and the rocket nozzle, said second combustion chamber configured to receive combustion products from the first combustion chamber;
a second oxidizer feed line connected to the second combustion chamber and configured to deliver oxidizer to the second combustion chamber from a supply of oxidizer; and
a second oxidizer feed valve connected to the second oxidizer feed line and configured to control a flow of oxidizer into the second combustion chamber.
